(19) United States
(12) Patent Application Publication
(10) Pub. No.: US 2006/0152846 A1
(43) Pub. Date: Jul. 13, 2006

(54) Servo writer and tape drive system

(75) Inventor: Keiichi Tsutsui, Odawara (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/299,737

(22) Filed: Dec. 13, 2005

(30) Foreign Application Priority Data
Jan. 12, 2005 (JP) 2005-005515

(51) Int. Cl. G11B 15/00

(52) U.S. Cl. 360/95

(57) ABSTRACT

A head unit includes a head, and a head guide assembly disposed adjacent to the head to restrict a displacement of a tape (tape-like storage medium) in a tape width direction with respect to the head. A tape drive system includes a tape guide arrangement disposed to guide the tape supplied from a supply reel to the head unit, passed across the head unit and led to a take-up reel. The tape guide arrangement includes a guide disposed adjacent to the head unit, and the guide is supported with an air bearing. In one embodiment, the guide includes a motor for rotating a contact surface of the guide around which the tape is wrapped, in accordance with movement of the tape.

### CROSS-REFERENCE TO RELATED APPLIATIONS

This application claims the foreign priority benefit under Title 35, United States Code, § 119 (a)-(d), of Japanese Patent Application No. 2005-005515, filed on Jan. 12, 2005 in the Japan Patent Office, the disclosure of which is herein incorporated by reference in its entirety.

### BACKGROUND OF THE INVENTION

This invention relates to a servo writer for writing a servo signal on a recordable tape or a tape-like storage medium, which servo signal is used for tracking control exercised over read/write heads, and to a tape drive system for driving a tape-like storage medium.

The rapid-paced advance of information recording/reading and storage medium technologies have been making storage media denser in recent years, and high-density packing has been realized optically or magnetically; for example, 400 gigabytes of data can be stored for computer backup on a reel of magnetic tape. For such high-density packing on a tape-like storage medium, hundreds of data tracks are arranged across the width of the tape. Accordingly, the widths of the data tracks have become very narrow, and the spacings between adjacent data tracks have become very narrow, too. Take, for example, a magnetic tape, in order to allow a read/write element of a magnetic head to trace the data tracks, servo control is exercised over the position (across the width of the magnetic tape) of the magnetic head, based on a servo signal that has been recorded beforehand on the magnetic tape using a write head of a servo writer (See JP 8-30942 A, paragraph 0021, FIG. 3).

The servo writer typically includes a tape drive system with a tape guide arrangement for guiding magnetic tap supplied from a supply reel to a predetermined position where writing and/or reading take place before the magnetic tape is wound up and accumulated around a take-up reel. To illustrate more specifically, referring to FIG. 6, a servo writer 11 is comprised principally of a tape drive system, a write head unit 14, and a read head unit 15. The tape drive system includes a supply reel 12, a take-up reel 13, a plurality of guide rollers R and a pair of tensioners T. In addition to the guide rollers R, provided as the tape guide arrangement in the tape drive system are: a bearing guide R₁ disposed immediately upstream of the write head unit 14 to guide the magnetic tape MT to the write head unit 14; a bearing guide R₃ disposed immediately upstream of the read head unit 15 to guide the magnetic tape MT to the read head unit 15; a bearing guide R₂ disposed immediately downstream of the write head unit 14 to guide the magnetic tap MT to the bearing guide R₃; and a bearing guide R₄ disposed immediately downstream of the read head unit 15 to guide the magnetic tape MT to a guide R₅ which in turn serves to guide the magnetic tape MT to one of the tensioner T located downstream. The bearing guides R₁-R₄ are adapted to guide edges of the magnetic tape MT, and thus play an important role in restricting an undesirable movement of the magnetic tape MT in a lateral direction, perpendicular to the edges, of the magnetic tape MT (hereinafter referred to as “tape width direction”), thereby preventing the magnetic tape MT from shifting widthwise, during writing and reading operations of the write head unit 14 and the read head unit 15, respectively.

The bearing guides R₁-R₄ are likely to vibrate due to their looseness in the tape width direction of the magnetic tape MT, which thus causes the magnetic tape MT sliding along a magnetic head 141 of the write head unit 14 to vibrate in the tape width direction, with the result that a servo signal written on the magnetic tape MT would disadvantageously not be neatly aligned with a servo band (i.e., not going straight ahead but meandering). Also, such vibration of the magnetic tape MT would disadvantageously lower the reliability of verification performed by a magnetic head 152 of the read head unit 15 for the servo signal written on the magnetic tape MT.

As the bearing guides R₁-R₄ wear out with use, rotation of each bearing guide R₁-R₄ becomes sluggish and thus unable to follow the movement of the magnetic tape MT. Resultantly, the edges of the magnetic tape MT are caused to rub against flanges of the bearing guides R₁-R₄, which would disadvantageously cause magnetic powder to be scratched off the magnetic tape MT, or otherwise damage the magnetic tape MT and other components. In addition, the edges of the magnetic tape MT caused to rub against the flanges of the bearing guides R₁-R₄, would disadvantageously intensify not only the vibration in the tape width direction of the magnetic tape MT sliding along the magnetic head 141 of the write head unit 14, but also the vibration in the tape 15 width direction of the magnetic tape MT sliding along the magnetic head 151 of the read head unit 15, with the former making it more difficult to write the servo signal straight on the servo band without meandering, the latter further lowering the reliability of verification performed by the magnetic head 152 of the read head unit 15 for the servo signal written on the magnetic tape MT.

With this in view, it would be desirable to provide a servo writer and a tape drive system in which the above disadvantages are overcome.

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

### SUMMARY OF THE INVENTION

It is an aspect of the present invention to provide a servo writer including a head unit and a tape drive system. The head unit includes a head, and a head guide assembly disposed adjacent to the head to restrict a displacement of a tape in a tape width direction with respect to the head. The tape drive system includes a tape guide arrangement disposed to guide the tape supplied from a supply reel to the head unit, passed across the head unit and led to a take-up reel. The tape guide arrangement includes a guide disposed adjacent to the head unit, the guide being supported with an air bearing.

With this construction, the support with the air bearing secures smooth rotation of the guide, and thus allows the guide to follow the tape stably. Moreover, since the guide supported with the air bearing rotates in synchronous with movement of the tape wrapped around the guide in the same direction and at the same speed, the inertia of the rotating guide stabilizes the rotational speed of the guide, so that vibration that would occur due to contact between the tape edge and the guide can be prevented. Further, because the vibration can be prevented, magnetic powder that could be generated due to rubbing of the tape edge against the guide caused by such vibration can be prevented.

In the above construction, the head guide assembly may, preferably but not necessarily, be provided to restrict the displacement of the tape at positions upstream and downstream of the head.

In one embodiment, the tape guide arrangement may further include a motor having a drive shaft, wherein the guide is fixed on the drive shaft of the motor, and the drive shaft is supported on the air bearing. In addition, the motor may be adapted to rotate the drive shaft in accordance with movement of the tape wrapped around the guide, which movement is caused by the tape drive system. According to this embodiment, once the motor on which the guide is fixed is activated, the guide can be caused to rotate in accordance with the movement of the running tape, whereby the property of the guide that allows the guide to follow the running tape can be enhanced.

In another embodiment, the tape guide arrangement may further include a motor having a motor housing and a drive shaft fixed relative to the head, which motor housing is shaped and disposed to serve as the guide, and supported on the air bearing. In addition, the motor may be adapted to rotate the motor housing in accordance with movement of the tape wrapped around the motor housing, which movement is caused by the tape drive system. According to this embodiment, similar to the above embodiment, once the motor of which the motor housing serving as the guide is supported on the air bearing is activated, the motor housing as the guide can be caused to rotate in accordance with the movement of the running tape, whereby the property of the guide that allows the guide to follow the running tape can be enhanced.

The guide as described above may, preferably but not necessarily, include a first guide disposed upstream of the head unit, and a second guide disposed downstream of the head unit. In this construction, the guide supported with an air bearing is provided both upstream and downstream of the head unit along the tape, and thus the vibration of the tape in the tape width direction can be reduced.

An angle of wrap with which the tape wraps around the guide may preferably but not necessarily be set at a fixed angle between 45° and 90° inclusive. In this configuration, the distance that the tape wraps around the guide can be so long that the guide supported with the air bearing is allowed to follow the tape more stably, whereby the vibration of the tape in the tape width direction can be reduced more effectively.

A tape edge guide portion of the head guide assembly and a tape edge guide portion of the guide may preferably but not necessarily be aligned within a tolerance of 100 μm in the tape width direction. In this arrangement, the tape edge guide portion of the guide can be prevented from strongly colliding with the tape edge.

A pressure of air introduced into the air bearing may preferably but not necessarily be set at 5±0.25 kg/cm². Alternatively or additionally, an amount of air introduced into the air bearing may preferably but not necessarily be set at 1.5 L/min. or smaller. An air outlet through which air introduced in the air bearing is jetted may be small and an inner hollow of the air bearing in which the introduced air is received may be substantially airtight enough to obviate the necessity to introduce a large amount of air into the inner hollow through an air inlet.

In yet another exemplary and more specific embodiment, the guide may include a hollow cylindrical roller having an outer cylindrical surface adapted to be wrapped with the tape, with a pair of annular flanges projecting from both ends of the hollow cylindrical roller in an outward direction substantially perpendicular to the outer cylindrical surface; and the air bearing may include a columnar shaft inserted in the hollow cylindrical roller of the guide, the columnar shaft having an inner hollow adapted to receive air introduced through an air inlet and to pressurize and jet the air through an air outlet into a gap provided between an inner cylindrical surface of the hollow cylindrical roller of the guide and a periphery of the columnar shaft of the air bearing.

The head may include, but not limited to, a write head for writing a servo signal on the tape. The head may include, but not limited to, a read head for reading a servo signal written on the tape by a write head for verification.

The tape may include, but not limited to, a tape-like magnetic storage medium. The tape may include, but not limited to, a tape-like optical storage medium.

In another aspect of the present invention, there is provided a tape drive system for driving a tape-like storage medium, to allow a head provided in a head unit to perform at least one of reading and writing functions for data on the tape-like storage medium. The tape drive system includes: a tape guide arrangement for guiding the tape-like storage medium supplied from a supply reel to the head unit, passed across the head unit and led to a take-up reel, the tape guide arrangement including first and second guides disposed adjacent to the head unit, upstream and downstream of the head unit, respectively, each of the first and second guides being supported with an air bearing; and a head guide assembly disposed adjacent to the head in the head unit to restrict a displacement of the tape-like storage medium in a tape width direction with respect to the head, at positions upstream and downstream of the head. In this setup, an angle of wrap with which the tape-like storage medium wraps around each of the first and second guides may preferably but not necessarily be set at a fixed angle between 45° and 90° inclusive, and a tape edge guide portion of the head guide assembly and a tape edge guide portion of each of the first and second guides of the tape guide arrangement may preferably but not necessarily be aligned within a tolerance of 100 μm in the tape width direction.

In one embodiment of the tape drive system, each of the first and second guides of the tape guide arrangement may further include a motor for rotating a contact surface of each guide around which the tape-like storage medium is wrapped, in accordance with movement of the tape-like storage medium.

### BRIEF DESCRIPTION OF THE DRAWINGS

The above aspects, other advantages and further features of the present invention will become more apparent by describing in detail illustrative, non-limiting embodiments thereof with reference to the accompanying drawings, in which:

FIG. 1 is a schematic diagram showing a servo writer according to an exemplary embodiment of the present invention;

FIG. 2 is a perspective view of a write head unit and air bearing guides as viewed from a bottom of FIG. 1;

FIG. 3A shows a longitudinal section of an air bearing guide according to one embodiment of the present invention;

FIG. 3B shows a cross section of the air bearing guide of FIG. 3A;

FIG. 4 shows a longitudinal section of an air bearing guide according to another embodiment of the present invention, with a motor incorporated therein;

FIG. 5 shows a longitudinal section of an air bearing guide according to yet another embodiment of the present invention, with a motor incorporated therein; and

FIG. 6 is a schematic diagram showing a conventional servo writer.

### DETAILED DESCRIPTION OF THE EXEMPLARY EMBODIMENTS

A detailed description of exemplary embodiments of the present invention will now be given with reference to the drawings.

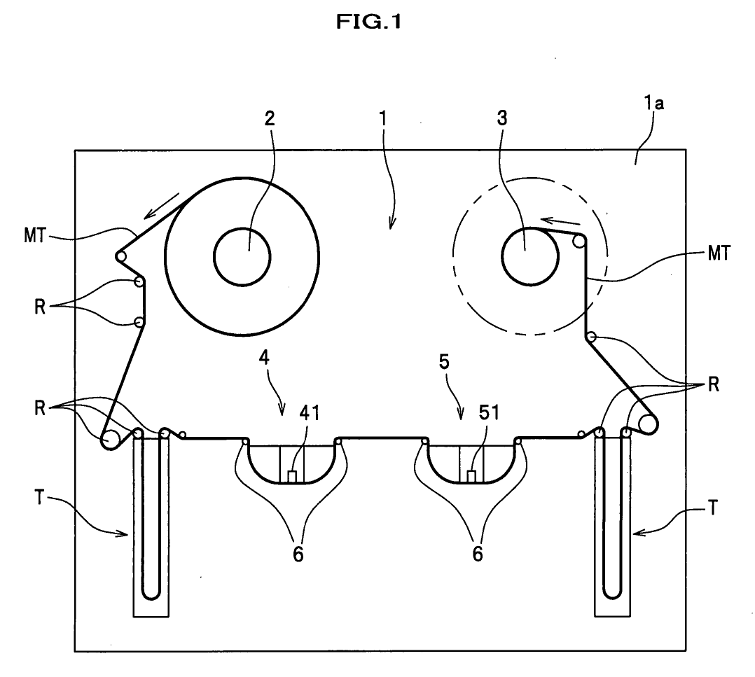

Referring now to FIG. 1, a servo writer 1 according to one exemplary embodiment of the present invention is provided principally with a supply reel 2, a take-up reel 3, a write head unit 4, and a read head unit 5. Other components further provided in the servo writer 1 include a tensioner T for adjusting a tension of a magnetic tape MT to a predetermined level, guide rollers R for guiding the magnetic tape MT, air bearing guides 6, a power supply (not shown), a drive unit (not shown) for the take-up reel 3, and a cleaning unit for cleaning the magnetic tape MT.

To manufacture the magnetic tape MT, a wide web roll of magnetic-coated base film is slit into tapes of a product width at the outset. The resulting magnetic tape MT is then wound up into a large-diameter pancake which in turn is set in the supply reel 2 prior to a time when writing of a servo signal takes place; thus, the supply reel 2 starts to supply the magnetic tape MT when writing of a servo signal begins. The magnetic tape MT supplied from the supply reel 2 is guided by the guide rollers R and the air bearing guides 6 to the write head unit 4 and then to the read head unit 5. The magnetic tape MT is passed across the write head unit 4 at which a servo signal is written on the magnetic tape MT, and the servo signal written on the magnetic tape MT is read at the read head unit 15 for verification purposes when the magnetic tape MT is passed across the read head unit 5. The magnetic tape MT is led to the take-up reel 3, which is driven by the drive unit to rotate so as to take up the magnetic tape MT on which the servo signal is written.

In this embodiment, the guide rollers R and the air bearing guides 6 correspond to components which constitute a tape guide arrangement as defined in the appended claims. Similarly, the tape guide arrangement and the drive unit correspond to components which constitute a tape drive system as defined in the appended claims.

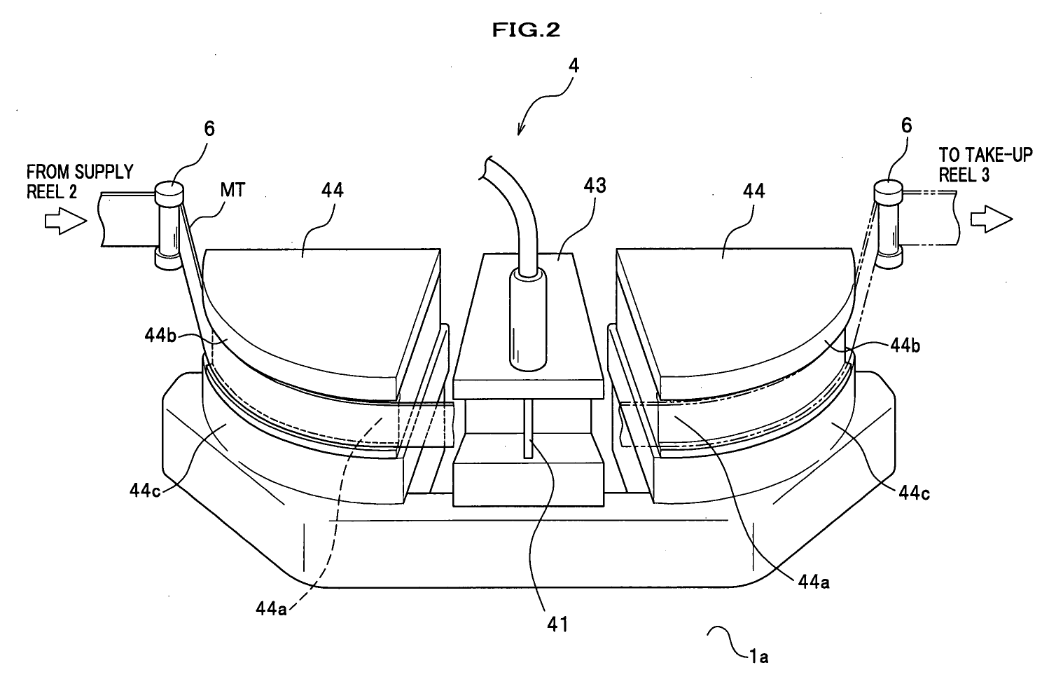

Turning to FIG. 2, the write head unit 4 according to the present embodiment includes a magnetic head 41, a head holder 43 that holds the magnetic head 41, and a head guide assembly 44 disposed adjacent to the head holder 43 in a position that permits the head holder 43 to be sandwiched between two portions 44, 44 positioned upstream and downstream thereof along the magnetic tape MT. In the write head unit 4, a driver for writing operation is incorporated, though not illustrated, which energizes the magnetic head 41.

The magnetic head 41 according to the present embodiment includes a coil (not shown) for inducing magnetic flux, and a head gap (not shown) is formed in the magnetic head 41 to write a servo signal.

The head holder 43 holds the magnetic head 41 in a fixed position such that the magnetic tape MT runs substantially in contact with the magnetic head 41 preferably with a modest angle of wrap formed between the magnetic head 41 and the magnetic tape MT.

The head guide assembly 44 includes a pair of guide faces 44a, 44a disposed at upstream and downstream portions (44, 44) thereof, respectively, to guide the magnetic tape MT, and upper and lower flanges 44b, 44c disposed at upper and lower edges of each guide face 44a, which flanges 44b, 44c extends downwardly (toward the front in FIG. 2) and sandwiches the magnetic tape MT running on the guide face 44a so as to restrict a displacement of the magnetic tape MT in a tape width direction with respect to the magnetic head 41. The guide face 44a is smoothly curved or arc-shaped so that the magnetic tape MT slides along the guide face 44a with a recording side of the magnetic tape MT in contact with the guide face 44a. The lower edge of the guide face 44a facing toward a panel side la is provided with the lower flange 44c along the running magnetic tape MT. The upper edge of the guide face 44a facing toward a human side is provided the upper flange 44b. The magnetic head 41 is held in the aforementioned head holder 43, and disposed between the upstream and downstream portions 44, 44 of the head guide assembly 44.

Returning to FIG. 1, the read head unit 5 is a verification head for performing a verification of a servo signal written on the magnetic tape MT by the write head unit 4. The read head unit 5 is provided downstream of the write head unit 4. The construction of the read head unit 5 is substantially the same as that of the write head unit 4, and thus a duplicate description will be omitted herein. A read head 51 provided in the read head unit 4 is adapted to read a servo signal written on the magnetic tape MT for verification.

Since the read head unit 5 has substantially the same construction as the write head unit 4, the state of the running magnetic tape MT at the write head unit 4 can be replicated at the read head unit 5 under the same conditions, so that an accurate verification can be performed.

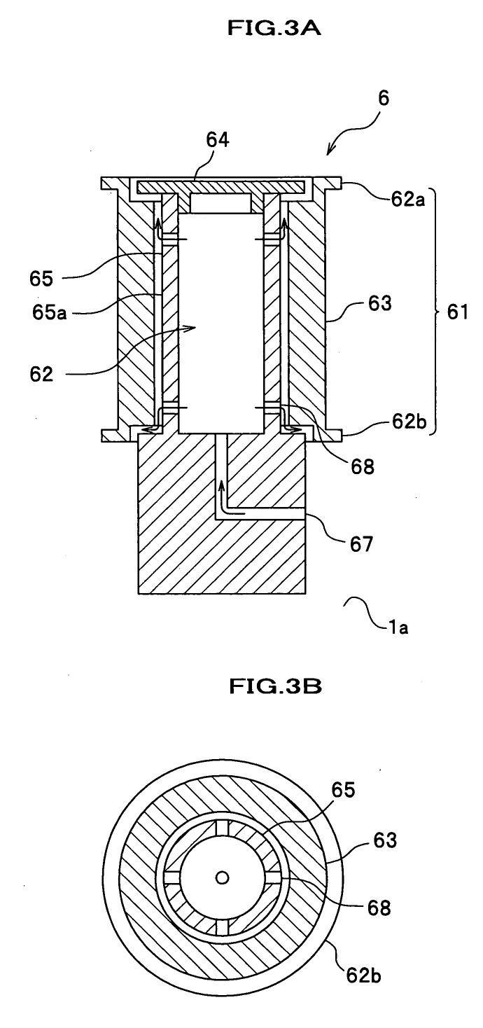

Next, a description will be given of air bearing guides 6 provided in the tape drive system of the servo writer according to an exemplary embodiment of the present invention, with reference to FIGS. 1 and 3. Four air bearing guides 6 are provided, as shown in FIG. 1, at positions adjacent to, and immediately upstream and downstream of, each of the write head unit 4 and the read head unit 5. As shown in FIG. 3A, the air bearing guide 6 in this embodiment includes a guide 61, a columnar shaft 65 and a top lid 64. The shaft 65 is inserted in a cylindrical hollow of the guide 61. The top lid 64 is fitted onto the shaft 65 to cover a hollow portion 62 (inner hollow) provided in the shaft 65. The shaft 65 having the hollow portion 62 covered with the top lid 64 constitutes an air bearing with which the guide 61 is supported, as defined in the appended claims.

The guide 61 includes a hollow cylindrical roller 63 and annular flanges (upper flange 62a and lower flange 62b) that are provided at both ends (at an upper end and at a lower end, respectively) in an axial direction of the roller 63 and project in an outward direction substantially perpendicular to a periphery (outer cylindrical surface) of the roller 63. The roller 63 is rotatably supported with the shaft 65, with a predetermined gap provided between a periphery of the columnar shaft 65 and an inner cylindrical surface of the hollow cylindrical roller 63. The periphery of the roller 63 is arranged to come in contact with a surface (recording side) of the magnetic tape MT so as to guide the running magnetic tape MT. An angle of wrap with which the magnetic tape MT wraps around the roller 63 is, preferably but not necessarily, set at a fixed angle between 45° and 90° inclusive. The upper flange 62a and the lower flange 62b are arranged to come in contact with edges of the magnetic tape MT when the magnetic tape MT would shift in the tape width direction so as to prevent the magnetic tape MT from undergoing a displacement in the tape width direction to such an extent that the magnetic tape MT comes off the roller 63. The lower flange 62b (tape edge guide portion) of the guide 61 and the lower flange 44c (tape edge guide portion) of the head guide assembly 44 (see also FIG. 2) are, preferably but not necessarily, aligned within a tolerance of ±100 μm in the tape width direction.

The columnar shaft 65 has a first end fixed on the panel side 1a, an insertion portion 65a inserted in the roller 63 to support the roller 63 in such a manner that the roller 63 can rotate, and a second end provided with the top lid 64 described above which serves to prevent the rotating roller 63 from coming off the shaft 65. The shaft 65 has the hollow portion 62 inside as described above. An air inlet 67 is provided in the first end of the shaft 65 to introduce air into the hollow portion 62. Air outlets 68 are provided in the insertion portion 65a of the shaft 65 to jet the air, which is introduced through the air inlet 67 and pressurized in the hollow portion 62, into the gap provided between the inner cylindrical surface of the hollow cylindrical roller 63 and the periphery of the columnar shaft 65.

In this embodiment, as shown in FIGS. 3A and 3B, eight air outlets 68 are provided in the insertion portion 65a of the shaft 65: four spaced out at an angle of 90° around the circumference in a first section near the first end of the shaft 65; and four spaced out at an angle of 90° around the circumference in a second section near the second end of the shaft 65. With consideration given to the amount of air to be jetted from the hollow portion 62 through the air outlets 68, the amount of air introduced through the air inlet 67 is set, for example, at 1.0 liter per minute.

Air jetted out through the air outlets 68 passes across the periphery of the insertion portion 65a through the gap between the inner cylindrical surface of the hollow cylindrical roller 63 and the periphery of the columnar shaft 65, and goes out of the air bearing guide 6. Since the air passes through the gap between the insertion portion 65a of the shaft 65 and the roller 63, the insertion portion 65a and the roller 63 fail to come in contact with each other during rotation of the roller 63 synchronized with movement of the running magnetic tape MT, so that wear and tear of the insertion portion 65a of the shaft 65 and the roller 63 can be prevented. Moreover, the roller 63 is consequently allowed to possess an improved property of being able to follow the magnetic tape MT.

Accordingly, the servo signal written on the magnetic tape MT by the magnetic head 41 of the write head unit 4 goes straight ahead along the servo band without meandering, so that the servo signal can be appropriately recorded on the magnetic tape MT. Further, the servo signal written on the magnetic tape MT can be read accurately by the magnetic head 51 of the read head unit 5. In this embodiment, the pressure of air introduced through the air inlet 67 is set, for example, at 5.0 kg/cm², but may be set otherwise as far as the pressure is enough to prevent the periphery of the insertion portion 65a of the shaft 65 and the inner cylindrical surface of the roller 63 from coming in contact with each other during the rotation of the roller 63, which can thus take place in synchronization with the movement of the running magnetic tape MT.

It is contemplated that various modifications and changes may be made to the exemplary embodiments of the invention without departing from the spirit and scope of the embodiments of the present invention as defined in the following claims.

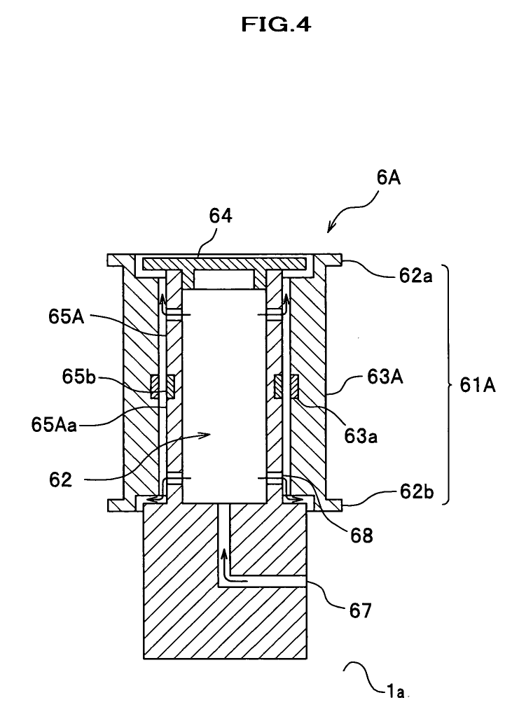

For example, in an alternative embodiment, the air bearing guide may be provided with a motor having a motor housing and a drive shaft. The drive shaft is fixed relative to the magnetic head 41 or 51 (see FIG. 2), and the motor housing is shaped and disposed to serve as a roller of a guide and supported on the air bearing. To be more specific, for example, as shown in FIG. 4, in which those parts corresponding to the components of FIG. 3A are identified with the same reference characters and a duplicate description is omitted herein, an air bearing guide 6A is provided with a motor comprised of a rotor magnet 63a embedded in an inner cylindrical surface of a hollow cylindrical roller 63A and a stator magnet 65b embedded opposite the rotor magnet 63a in a periphery of an insertion portion 65Aa of a columnar shaft 65A, so that a guide 61A rotates at a predetermined rotational speed in a predetermined rotational direction. Preferably, the motor may be adapted to rotate the roller 63A of the guide 61A (motor housing) in accordance with movement of the magnetic tape MT wrapped around the roller 63A. For that end, the motor may be driven in synchronization with the take-up reel 3 driven by the drive unit (see FIG. 1). The motor comprised of the rotor magnet 63a and the stator magnet 65b contributes to further improvement in the property of the guide 61A being able to follow the magnetic tape MT.

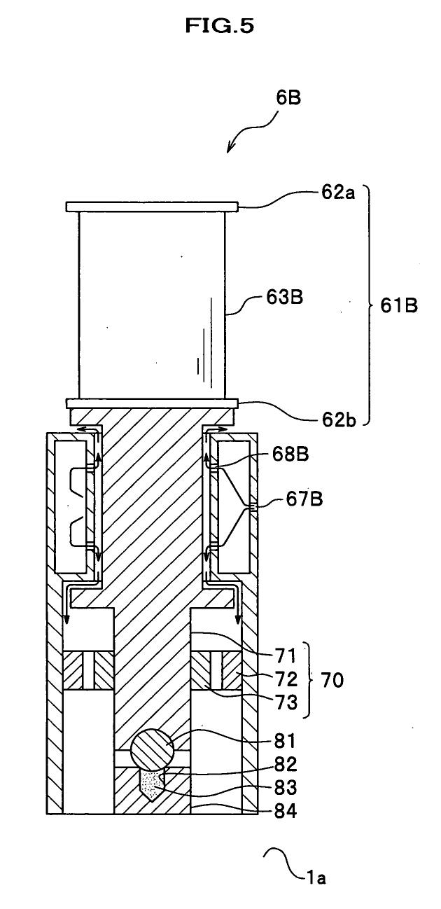

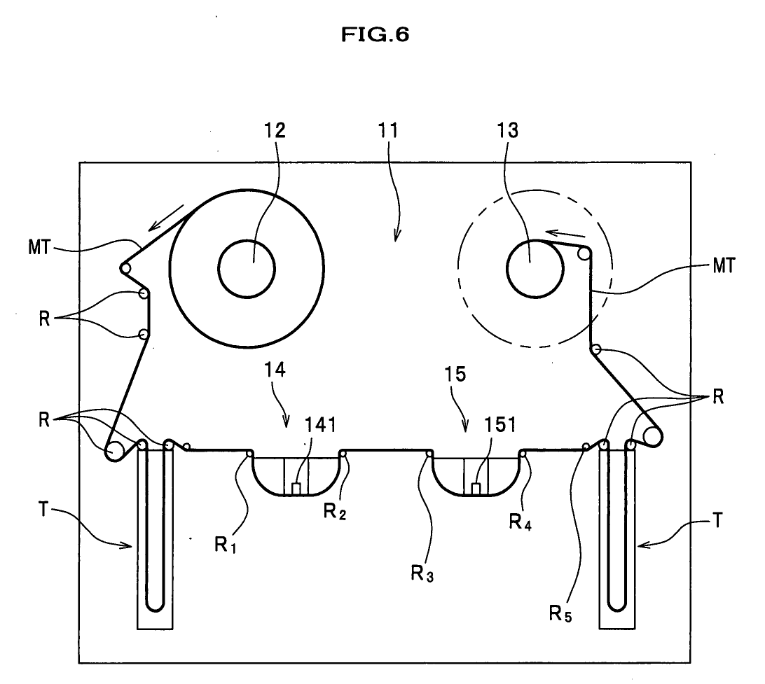

In yet another alternative embodiment, the air bearing guide may be provided with a motor having a drive shaft. A guide is fixed on the drive shaft of the motor and the drive shaft is supported on the air bearing. To be more specific, for example, as shown in FIG. 5, an air bearing guide 6B is provided with a motor 70 having a drive shaft 71 on which a roller 63 is fixed. The drive shaft 71 is supported on the air bearing and floats with air introduced through an air inlet 67B and jetted through an air outlet 68B. In FIG. 5, which is a longitudinal section of the air bearing guide 6B with the motor 70 incorporated therein, those parts corresponding to the components of FIG. 3A are identified with the same reference characters and a duplicate description is omitted herein. The air introduced through the air inlet 67B is jetted through the air outlet 68B toward a periphery of the drive shaft 71 of the motor 70. The motor 70 is comprised of a drive shaft 71, a stator magnet 72 and a rotor magnet 73. At a lower end of the drive shaft 71 is provided a ball 81 which rotates in synchronization with the drive shaft 71 and electrically connected with an electrically conductive pad 84 provided under the ball 81. The ball 81 has a spherical surface made of metal, and half of an upper hemisphere is embedded in the lower end of the drive shaft 71. The electrically conductive pad 84 serves to electrically connect the drive shaft 71 through the ball 81 to the panel side 1a. On a top side of the electrically conductive pad 84 is provided a hole 82 at a location facing to the ball 81, and the hole 82 is filled with electrically conductive grease 83. The hole 82 serves as a grease cup to hold a predetermined amount of the grease 83. The electrically conductive pad 84 is electrically connected by a lead wire, conductive plate or the like to the panel side la and is grounded, though not illustrated in FIG. 5. In the air bearing guide 6B constructed as described above, a small centrifugal force that occurs as the ball 81 rotates together with the drive shaft 71 causes the grease 83 in the hole 82 to move upward on the outer spherical surface of the ball 81, thus forming a thin film of oil at a contact between the ball 81 and the electrically conductive pad 84. The lubricity of the film of oil causes the ball 81 to smoothly rotate. Preferably, the motor 70 may be adapted to rotate the roller 63B of the guide 61B in accordance with movement of the magnetic tape MT wrapped around the roller 63B. For that end, the motor may be driven in synchronization with the take-up reel 3 driven by the drive unit (see FIG. 1). The motor 70 having the drive shaft 71 on which the guide 61B is fixed contributes to further improvement in the property of the guide 61B being able to follow the magnetic tape MT.

In the above exemplified embodiments, one air inlet for introducing air into the air bearing is provided but the number of air inlets is not limited to one, and more than one (i.e., two, three, four, five or any other number, where appropriate) of such air inlets may be applicable if the conditions permit. Similarly, the number of air outlets for jetting the introduced air is not limited to eight as provided in the above embodiments by way of example, but two, three, four, five, six, seven, nine, ten or any other number of such air outlets may be provided as far as the roller and the shaft is not brought into contact with each other when the guide rotates.

According to the embodiments as described above, a write head can write data straight ahead along a predetermined area on a tape-like storage medium, and a read head can read data securely and precisely from a predetermined area on a tape-like storage medium. More specifically, a servo writer capable of writing a servo signal straight ahead along a predetermined servo band on a tape-like storage medium and reading a servo signal securely and precisely from a predetermined servo band for verification can be provided.

What is claimed is:

1. A servo writer comprising:
a head unit including a head, and a head guide assembly disposed adjacent to the head to restrict a displacement of a tape in a tape width direction with respect to the head; and
a tape drive system including a tape guide arrangement disposed to guide the tape supplied from a supply reel to the head unit, passed across the head unit and led to a take-up reel,
wherein the tape guide arrangement includes a guide disposed adjacent to the head unit, the guide being supported with an air bearing.

2. A servo writer according to claim 1, wherein the head guide assembly is provided to restrict the displacement of the tape at positions upstream and downstream of the head.

3. A servo writer according to claim 1 wherein the tape guide arrangement further includes a motor having a drive shaft, and the guide is fixed on the drive shaft of the motor, the drive shaft being supported on the air bearing.

4. A servo writer according to claim 3, wherein the motor is adapted to rotate the drive shaft in accordance with movement of the tape wrapped around the guide, the movement being caused by the tape drive system.

5. A servo writer according to claim 1, wherein the tape guide arrangement further includes a motor having a motor housing and a drive shaft fixed relative to the head, which motor housing is shaped and disposed to serve as the guide, and supported on the air bearing.

6. A servo writer according to claim 5, wherein the motor is adapted to rotate the motor housing in accordance with movement of the tape wrapped around the motor housing, the movement being caused by the tape drive system.

7. A servo writer according to claim 1, wherein the guide comprises a first guide disposed upstream of the head unit, and a second guide disposed downstream of the head unit.

8. A servo writer according to claim 1, wherein an angle of wrap with which the tape wraps around the guide is set at a fixed angle between 45° and 90° inclusive.

9. A servo writer according to claim 1, wherein a tape edge guide portion of the head guide assembly and a tape edge guide portion of the guide are aligned within a tolerance of 100 μm in the tape width direction.

10. A servo writer according to claim 1, wherein a pressure of air introduced into the air bearing is set at 5±0.25 kg/cm².

11. A servo writer according to claim 1, wherein an amount of air introduced into the air bearing is set at 1.5 L/min. or smaller.

12. A servo writer according to claim 1, wherein the guide comprises a hollow cylindrical roller having an outer cylindrical surface adapted to be wrapped with the tape, with a pair of annular flanges projecting from both ends of the hollow cylindrical roller in an outward direction substantially perpendicular to the outer cylindrical surface; and
wherein the air bearing comprises a columnar shaft inserted in the hollow cylindrical roller of the guide, the columnar shaft having an inner hollow adapted to receive air introduced through an air inlet and to pressurize and jet the air through an air outlet into a gap provided between an inner cylindrical surface of the hollow cylindrical roller of the guide and a periphery of the columnar shaft of the air bearing.

13. A servo writer according to claim 1, wherein the head comprises a write head for writing a servo signal on the tape.

14. A servo writer according to claim 1, wherein the head comprises a read head for reading a servo signal written on the tape by a write head for verification.

15. A servo writer according to claim 1, wherein the tape comprises a tape-like magnetic storage medium.

16. A servo writer according to claim 1, wherein the tape comprises a tape-like optical storage medium.

17. A tape drive system for driving a tape-like storage medium, to allow a head provided in a head unit to perform at least one of reading and writing functions for data on the tape-like storage medium, the tape drive system comprising:
a tape guide arrangement for guiding the tape-like storage medium supplied from a supply reel to the head unit, passed across the head unit and led to a take-up reel, the tape guide arrangement including first and second guides disposed adjacent to the head unit, upstream and downstream of the head unit, respectively, each of the first and second guides being supported with an air bearing; and
a head guide assembly disposed adjacent to the head in the head unit to restrict a displacement of the tape-like storage medium in a tape width direction with respect to the head, at positions upstream and downstream of the head.

18. The tape drive system according to claim 17, wherein an angle of wrap with which the tape-like storage medium wraps around each of the first and second guides is set at a fixed angle between 45° and 90° inclusive.

19. The tape drive system according to claim 17, wherein a tape edge guide portion of the head guide assembly and a tape edge guide portion of each of the first and second guides of the tape guide arrangement are aligned within a tolerance of 100 μm in the tape width direction.

20. The tape drive system according to claim 17, wherein each of the first and second guides of the tape guide arrangement further comprises a motor for rotating a contact surface of each guide around which the tape-like storage medium is wrapped, in accordance with movement of the tape-like storage medium.
